(19) United States
(12) Patent Application Publication
(10) Pub. No.: US 2004/0039648 A1
(43) Pub. Date: Feb. 26, 2004

(54) Method and apparatus for downloading data to a set top box

(75) Inventors: Brant L. Candelore, Escondido, CA (US); Matthew Chang, San Diego, CA (US); Nicholas Colsey, Del Mar, CA (US); Mark Kenneth Eyer, Woodinville, WA (US); Dayan Ivy Golden, San Diego, CA (US); Aditya Krishnan, San Diego, CA (US); Andrew M. Proehl, San Francisco, CA (US); Peter Rae Shintani, San Diego, CA (US); David K. L. Yang, Rancho Santa Fe, CA (US); Frederick J. Zustak, San Diego, CA (US)

Correspondence Address: ROGITZ & ASSOCIATES, Suite 3120, 750 B Street, San Diego, CA, 92101, US

(73) Assignees: SONY CORPORATION, Tokyo (JP); SONY ELECTRONICS INC., Park Ridge, NJ

(21) Appl. No.: 10/225,339

(22) Filed: Aug. 20, 2002

(51) Int. Cl. G06F 17/60

(52) U.S. Cl. 705/26

(57) ABSTRACT

A method, apparatus computer program, and storage medium for storing the computer program for downloading a data program to a computing device are provided. The method comprises the steps of designating a data program; receiving the designated program at a set top box; and transferring the received data program from the set top box to the computing device.

### I. BACKGROUND OF THE INVENTION

The use of personal digital assistants and other handheld portable devices such as cell phones and the like has proliferated greatly in recent years. With this proliferation has grown the desire and ability to modify and personalize each of these portable devices for use by an individual user. Thus, rather than being required to use preloaded programs and other predetermined features of a particular device, the user is able to add additional programs, and often add on hardware modules that allow for the customization of these devices in many ways. The use of such additional programs and hardware modules results in a more personalized look and feel, and a better user experience. The user is therefore more likely to use the particular portable device.

To download and order a new program for a personal computing device, typically, a user must visit a website via the worldwide web and Internet that specializes in the sale or provision of computer programs and the like for the particular desired device. A user with a particular handheld device must visit a website and then scroll or enter a subpage of the website directed to the particular device. After reaching this area, the user can normally search through available programs to determine which program he or she would like to purchase and install. Finally, after selection, the program is delivered to the user. This program may either be downloaded directly into the user's computer, or sent to the user on a storage disk or the like.

If downloaded directly to the user's computer, typically, a predetermined number of steps are required for a user to then upload the program from the personal computer to the portable computing device. While this procedure is normally automated, it still requires a number of steps by the user, such as selection of the program, indication of a desire to upload the program, and any other steps typically employed for transferring data from the computer to portable computing device. Furthermore, if the program is received by the user via storage medium, it is necessary to insert the storage medium in the computer, open the program, and go through any number of predetermined steps for loading the program to the portable computing device in a manner such as that noted above.

While ordering such a program from the computer has some drawbacks, perhaps the greatest drawback is the inability for advertising and demonstrations of the program other than standard banner and other computer advertising. Because on a computer, users must click through a banner advertisement in order to see advertising, it may be unlikely that a user will view advertising for a particular product that may turn out to be of interest to the particular user.

Additionally, in recent years, the ability to purchase various goods on a home shopping network via a television has become popular. In such a network, various products are displayed, and the user is given the ability to purchase the product. A demonstration or the like might be performed to entice the viewer to purchase the product. In order to purchase a particular product, the user dials a predetermined telephone number, and enters or provides a product code. Upon entry, a user provides a credit card number, and the credit card is charged the cost of the product. Thereafter, the product is delivered to the user via standard well known delivery methods.

If a user were to select to purchase a computer program from the home shopping network, the program would be purchased on a recording medium, in a box with manual and the like. After the procedure noted above for paying for the product, the product would be shipped to the user in a standard manner.

While the method of purchasing software via the Internet, and purchasing other goods including software in accordance with a home shopping network program are useful in their own fields, the ability to combine the two has been limited.

In addition often a user is watching a television program and is interested in the program. Or, the user might be listening to an audio program, and would like more information. Currently, for a television program a user can look up a small amount of information in the television listings. Further information is normally unavailable for an audio radio program.

Finally, while a user can receive updated information at a portable device via one or more synchronization schemes, the categories of information are fixed, and cannot be changed without a number of content selection steps on a computer via the Internet.

Thus it would be beneficial to be able to obtain additional information about video or audio programs being viewed by the user.

### II. OBJECTS OF THE INVENTION

It is therefore an object of the invention to provide an improved method and apparatus for purchasing software, especially for portable computing devices.

Another object of the invention is to provide an improved method and apparatus whereby a user may order a computer program via a home shopping network.

A still further object of the invention is to provide an improved method and apparatus whereby a user can purchase a computer program in accordance with a home shopping network program, and the contents of the computer program are downloaded to the set top box of a user.

A still further object of the invention is to provide an improved method and apparatus whereby upon the purchase of a computer program at a home shopping network, and download the computer information to a user set top box, transfer of the computer program from the user set top box to a portable computing device is performed.

Yet another object of the invention is to provide an improved method and apparatus for allowing additional information about a video or audio program being viewed or heard by a user and downloaded via a set top box to a portable computing device.

Still other objects and advantages of the invention will in part be obvious and will in part be apparent from the specification and the drawings.

### SUMMARY OF THE INVENTION

In accordance with the invention, a method and apparatus are provided whereby a user watching a television program, such as a home shopping network, travel channel, news program or the like, can download simulcasted information to the user's set top box, which is then transferred to a portable computing device. Upon the viewing of an advertisement for a particular computer program on, for example, a home shopping network, the user indicates a preference for that program. The program is then downloaded to the user's set top box upon an indication of payment, or alternatively, the program is downloaded to the user's set top box before payment. Payment may be required prior to transferring of the information from the set top box to the user's portable computing device. Also, trial periods may be allowed, and free downloads including advertising may be employed. Credit card information may also be stored in the set top box as necessary and easily provided at the touch of a button.

In addition, the user watching a particular news program or the like, and indicating a preference for that program, receives extended information regarding that program downloaded to the user's set top box and transferred to the user's portable computing device. Advertising may be included. Other items that may be transferred include television schedules, travel information, stock quotes, weather reports or the like.

It is contemplated that the information be transferred to the personal computing device from the set top box via a wireless transmission scheme such as BLUETOOTH™, but may also employ any other transmission scheme.

Therefore, in accordance with the invention, a user is able to view various information on a television, or listen to various information on a radio, and upon an indication of a desire to receive additional information about any such program, receive this additional information via the user's set top box, and have this information transferred seamlessly to a portable computer device.

The invention accordingly comprises the several steps and the relation of one or more of such steps with respect to each of the others, and the apparatus embodying features of construction, combinations of elements, and the arrangement of parts that are adapted to effect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 is an overall schematic diagram showing the interrelationship between various head-end and user-end elements of a data transmission system in accordance with the invention;

FIG. 2 is a detailed block diagram of the internal structure of a set top box constructed in accordance with the invention;

FIG. 3 depicts an overall block diagram depicting a relationship of the elements of the invention including a personal computing device in accordance with the invention;

FIG. 4 is a flow chart diagram depicting the downloading of information in accordance with the invention; and

FIG. 5 is a flow chart diagram depicting the downloading of information in accordance with an alternative embodiment of the invention.

### DETAILED DESCRIPTION OF THE PREFERRED EMBODIMENTS

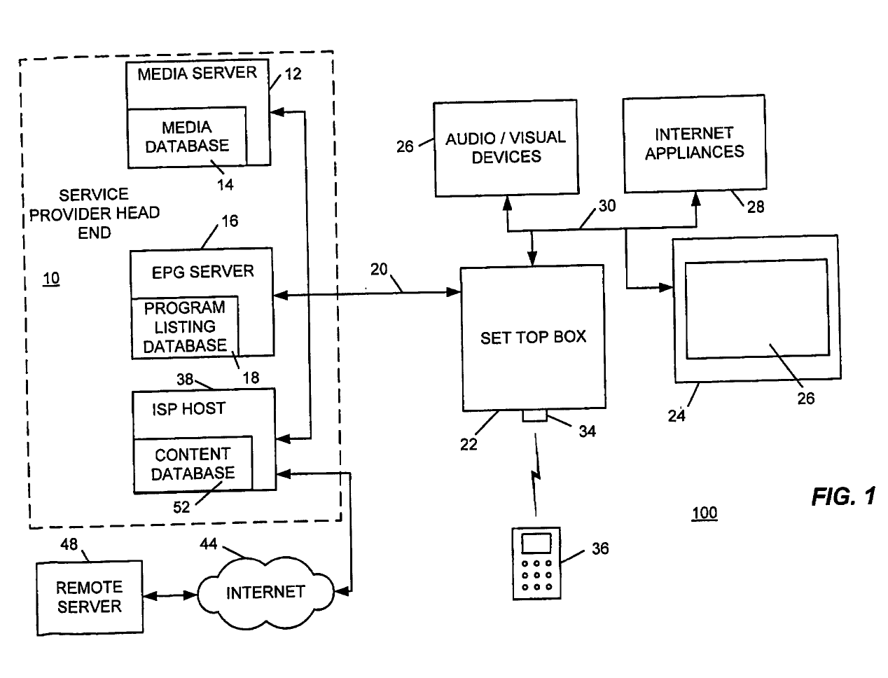

Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 may also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques such as dual communication media—one for the uplink and one for the downlink. In any event, the STB 22 may be provided with its own Universal Resource Locator (URL) assigned thereto to provide for addressability by the head end and users of the Internet.

The media server 12 and EPG server 16 are coupled by transmission medium 20 to a set top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB.

The exemplary system 100 further includes a TV 24, such as a digital television, having a display 26 for displaying programming, an EPG, etc. The STB 22 may be coupled to the TV 24 and various other audio/visual devices 26 and Internet Appliances 28 by an appropriate interface 30, which may be any suitable analog or digital interface. In one embodiment, interface 30 conforms to an interface standard such as the Institute of Electrical and Electronics Engineers (IEEE) 1394 standard. The STB 22 may include a central processing unit (CPU) and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g. using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

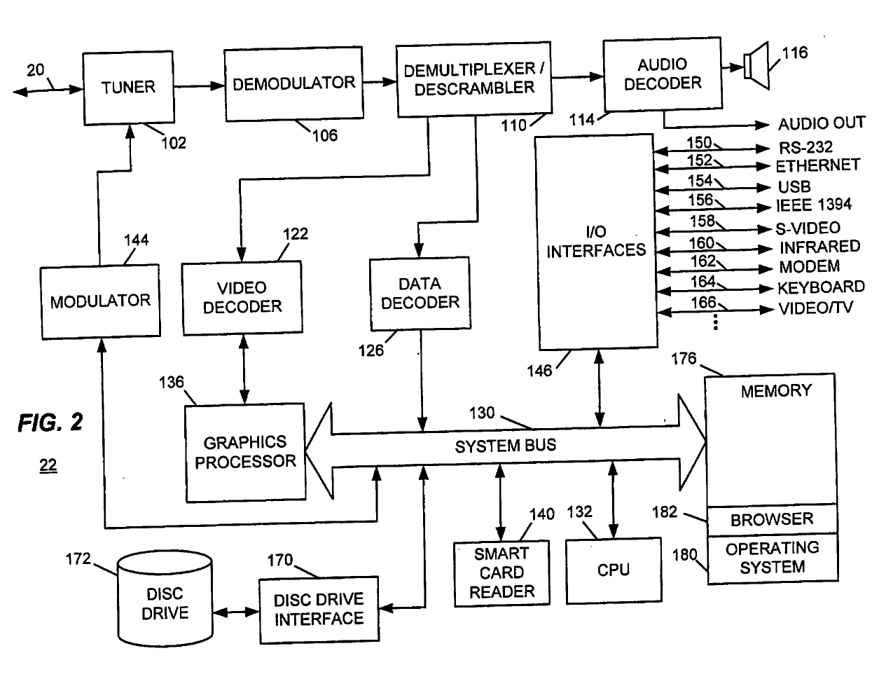

Referring next to FIG. 2, a typical system configuration for a digital set-top box 22 is illustrated. In this exemplary set-top box, the transmission medium 20, such as a coaxial cable, is coupled by a suitable interface to a tuner 102. Tuner 102 may, for example, include a broadcast in-band tuner for receiving content, an out-of-band (OOB) tuner for receiving data transmissions and a return path tuner for providing an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g. audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g. stereo or home theater multiple channel audio systems) or other audio system 116 (e.g. stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card”, often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the tuner (operating as a return path OOB tuner) and out through the transmission medium 20. This capability is used to provide a mechanism for the STB 22 and/or its user to send information to the head end (e.g. service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire or i-link) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bi-directional communication via the DOCSIS cable modem with the STB 22 being identified by an unique URL (Universal Resource Locator).

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 may include a disc drive interface 170 and disc drive mass storage 172 for user storage of content and data as well as providing storage of programs operating on CPU 132. STB 22 may also include floppy disc drives, CD ROM drives, CD RIW drives, DVD drives, etc. CPU 132, in order to operate as a computer, is coupled through the system bus 130 to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention.

In general during operation of the STB 22, an appropriate operating system 180 such as Sony Corporation's Aperios™ real time operating system is loaded into, or is permanently stored in, active memory along with the appropriate drivers for communication with the various interfaces. Along with the operating system and associated drivers, the STB 22 usually operates using browser software 182 in active memory or may permanently reside in ROM or EEPROM. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all include at the lowest layer various hardware interface layers. Next is an operating system layer as previously described. The software architectures of modern STBs have generally evolved to include a next layer referred to as “middleware”. Such middleware permits applications to run on multiple platforms with little regard for the actual operating system in place. Middleware standards are still evolving at this writing, but are commonly based upon JavaScript and HTML (HyperText Markup Language) virtual machines. At the top layer is the application layer where user applications and the like reside (e.g. browsing, email, EPG, Video On Demand (VOD), rich multimedia applications, pay per view, etc.). The current invention can be utilized with any suitable set-top box software architecture.

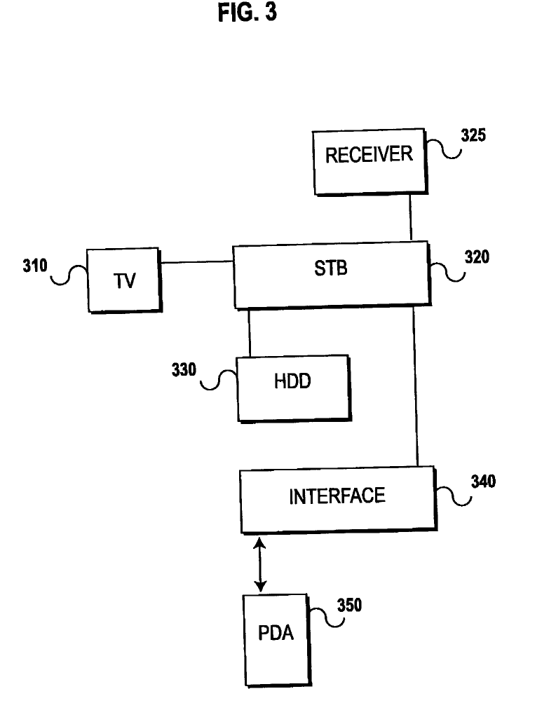

Referring next to FIG. 3, a standard television receiver 310 is shown. This television receiver 310 includes all standard television equipment, including a tuner, audio and video inputs. The tuner in television 310 is used for tuning one of a plurality of channels received via the video and audio inputs, or may be bypassed if an external tuner is provided. In accordance with FIG. 3, TV 310 receives its audio and video inputs from a set top box 320. Set top box 320 receives various transmitted information via a receiver 325 and stores appropriate information therein as described above. Upon selection of a particular channel or the like, as is described above, information is transmitted from set top box 320 to TV 310 for display to a user. As is further noted above, a hard disk drive 330 is provided within set top box 320, and stores various received programming information. In accordance with set top box 320 of the invention, a data downloading interface 340 is provided, similar to such an interface noted above. This interface 340 is able to communicate via one of a plurality of methods with a personal computing device PDA (Personal Digital Assistant) 350. The communication method between interface 340 and PDA 350 may be wireless, such as employing a BLUETOOTH™ transmission, other wireless transmission, infrared transmission, direct coupling of PDA 350 with set top box 320 or other known wired communication. While a PDA is shown, any portable device may be employed. Any such portable device would include cellular telephones, portable computers, or the like. This interface allows for the easy transfer of information form the set top box to the portable computing device.

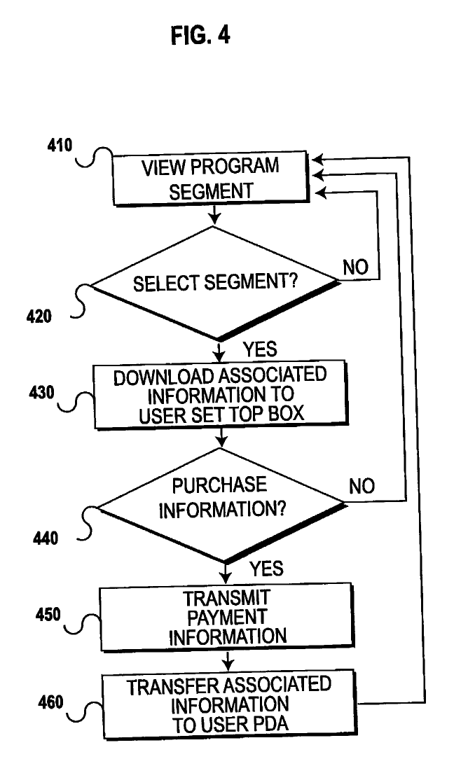

Referring next to FIG. 4, a discussion of a download process in accordance with an embodiment of the invention is shown. As is shown at step 410, a user views a particular program segment. In accordance with this embodiment of the invention, the program segment that is being viewed has associated information that is available for purchase. This is most likely a home shopping network demonstration or the like. The associated information may be a downloadable computer program, for example Any commercial advertisement may provide a similar type of associated data. Furthermore, even a standard television show or sports event may have data associated therewith that may be purchased. All of these scenarios are contemplated in accordance with this embodiment of the invention.

While viewing, control passes to step 420, where it is determined whether a user has selected a particular program segment. To select the particular program segment, the user presses a button on a remote control, or employ any other appropriate data entry mechanism provided to the user. A user may select a particular program segment if he or she is interested in obtaining additional associated information. As noted above, this associated information is preferably for sale. If a particular program segment is not selected by the user, control passes back to step 410 to view a next program segment.

However, if at step 420, a particular program segment is selected by a user, control then passes to step 430 where predetermined associated information from the selected program segment is downloaded to the user's set top box. After being downloaded, control passes to step 440 where it is determined whether the user wishes to purchase the downloaded information. Thus, even once the associated information is downloaded, the user must confirm purchase. This allows for a modification of the invention where the headend provider “pushes” data to the set top box without being requested by the user. This info can then be sold to a user. If the user does not wish to purchase this data, control returns to step 410 and a next program segment is viewed.

If, at step 440, it is determined that the user wishes to purchase the downloaded information, payment information is transmitted from the user's set top box to the headend provider at step 450. This payment information may be provided to the set top box on demand by a user, and the user enters the payment information data when prompted. The information may also be entered employing a credit card swipe machine. This payment information data may comprise a credit card number, or an online payment service, such as PAYPAL™ or the like. Additionally, rather than providing the payment information when prompted, this payment information may be stored within the set top box prior to viewing. When desired, this information may be transmitted to a headend provider without re-entering the information.

After receipt of payment information by the headend provider, at step 460, the downloaded associated information is transferred to the user's PDA portable computing device in the manner noted above. In this way, it is possible to allow for the download of associated information from a program segment to a user's set top box, to allow for the purchase of this information, and to allow for the automatic downloading of the information to a portable computing device.

In accordance with the invention, the personal computing device comprises one of a cell phone, personal digital assistant (PDA), portable PC, or any other portable computing device. Additionally, as noted above, information may be transferred from the set top box to the PDA or other portable computer device via a data port direct connection, extended wired connection, or wireless connection such as BLUETOOTH™ or the like. Furthermore, the transfer information can be in any desired format, including MPEG1, MPEG2, MPEG4 (a new encrypted and data format) as well as any other audio and/or video format.

In addition to the precise order to steps depicted in FIG. 4, alternative ordering sequences are contemplated in accordance with the invention. Therefore, rather than requiring purchase information to be transmitted upstream after downloading of associated information to the user's set top box, step 440 may be performed prior to step 430, thereby requiring the transmission of purchase information to the headend provider prior to downloading of the associated information to the user's set top box.

Furthermore, while the general steps shown in FIG. 4 may be employed, it may be possible to provide a free trial period for the software. While payment information may be transmitted at step 450, it is possible to hold back charging for the software until a predetermined period of time has elapsed. If a user is entitled to a thirty day free time period, and the user does not delete, or remove the data from the personal computing device within the thirty day time period, the user's credit card payment information is charged. In accordance with the invention, if a user wishes to return the software, the user would re-establish a link with the set top box, and perform a predetermined procedure whereby the set top box confirms deletion of the program. In such a situation, no charging of the user payment information would be made.

In addition to the ability noted above for the set top box to store user payment information, because programs are typically directed for a particular device, the set top box may also know the format of the user's PDA. Therefore when a user selects a particular program segment, the set top box also automatically transmits user information regarding the desired download format. In this manner, an appropriate data format can be employed. Alternatively, data of one or more of a plurality of formats may be provided to the set top box, and a selection of one of the formats for transfer to the user's PDA can be made later, either manually or automatically.

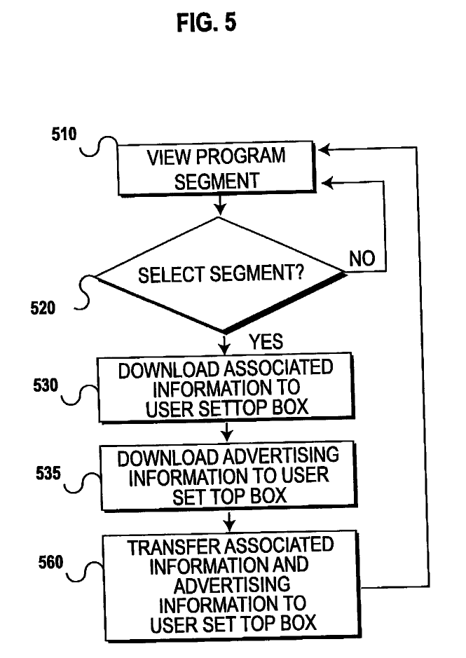

Next, an alternative embodiment of the invention is depicted in FIG. 5. A sequence of steps not requiring payment information, but rather employing advertising information is depicted. As is shown in FIG. 5, a user views a program segment at step 510, and at step 520 has the opportunity to select the particular program segment. If a particular program segment is not selected, control passes back to step 510 and a next program segment is viewed, similar to the steps in FIG. 4.

However, if at step 520 a particular segment is selected, control passes to step 530 and information associated with the selected program segment are downloaded to the user's set top box. In addition, at step 535, advertising information is also downloaded to the user's set top box.

Thereafter, upon indication by a user at step 560, the associated information and advertising information downloaded to the user's set top box is transferred to the user's portable computing device. In accordance with this embodiment of the invention, no payment is required for the information. However, advertising information is provided in order to assist in funding. This sequence of steps is most appropriate when associated information being downloaded in accordance with the selected program segment is not a computer program or the like that is to be purchased, but rather comprises freely available information.

For example, if a user is watching a news program, and more particularly either the sports or weather section, upon indication by a user, various weather or sports information may be downloaded to the user's set top box. Along with advertising information, this combination is then downloaded to the user's portable computing device. Upon viewing of the weather information by the user, the advertising information would also be shown.

Furthermore, if a user is viewing a particular commercial on a television, the user indicates a desire to receive more information regarding a product depicted in the advertisement. Associated information is downloaded to the user's set top box, as well as advertising or other related data depicting additional products that the user might be interested in. These products may be selected as simply associated with the product described in the advertisement, or may also be based upon a predetermined user profile stored within the user's set top box, or elsewhere so that additional advertising for products that a user may be interested in are included.

In another alternative embodiment of the invention, a user may opt to download a television schedule for a particular channel, or group of channels, simply by making such an indication. A live download would be indicated and would be transmitted to user's set top box, and then transferred to the user's PDA. In addition, if a user is watching a particular movie or program, additional information regarding the program, such as background, and actors and actresses in the program may also be downloaded, for example. In order to pay for this service, as noted above advertising information may be included, but need not be.

Therefore, in accordance with the invention, it is possible for a user to view a commercial or other demonstration for a particular computer software product. Upon selection and payment, the software product can be downloaded to a user's set top box, and ultimately to user's personal computing device. In addition to requiring payment for this information, additional information associated with a viewed program, program segment, new segment or the like, may be provided. This additional information further comprises advertisements or the like in order to assist in payment for the downloading of the information.

While this invention has been described with reference to a video program, it is not limited thereto. Thus, if a user is listening to a program or commercial, an emarker (manufactured and provided by Sony Corporation and described in U.S. patent application Ser. No. 09/905,355, filed Jul. 13, 2001, the entire contents thereof being incorporated herein by reference) may be utilized to designate the audio program segment in a manner known in the art. Upon such a designation, associated information is forwarded to a user's set top box and then downloaded to the user's PDA. Such designation requires a data transfer to send the requested program designations from the user's PDA to the set top box before downloading.

It will thus be seen that the objects set forth above, among those made apparent from the preceding description, are officially attained and, because certain changes may be made in carrying out the above method and in the constructions set forth without departing from the spirit and scope of the invention, it is intended that all matter contained in the above description and show in the accompanying drawings shall be determined as illustrative and not in the limiting sense.

It is also to be understood that the following claims are intended to cover all of the generic and specific features of the invention hereindescribed, and all statements of the scope of the invention to which, as a matter of language, might be said to fall therebetween.

What is claimed is:

1. A method for selecting a data program to be downloaded to a computing device, comprising the steps of:
designating a data program; and
receiving said designated program at a set top box.

2. The method of claim 1, wherein said data program is designated during a video advertisement thereof.

3. The method of claim 1, wherein said data program is designated during an audio advertisement thereof.

4. The method of claim 1, wherein said data program is designated during a video demonstration thereof on a television, said television being coupled with said set top box.

5. The method of claim 4, wherein said video demonstration comprises a session on a home shopping channel.

6. The method of claim 1, further comprising the step of designating a format of said computing device, a version of said designated data program corresponding to said designated format being received at said set top box.

7. The method of claim 1, wherein a plurality of versions of said designated data program corresponding to a plurality of formats of said computing device are received at said set top box.

8. The method of claim 1, wherein said computing device is a personal computer.

9. The method of claim 1, wherein said computing device is a PDA.

10. The method of claim 1, wherein said computing is a telephone.

11. A method for downloading a data program to a computing device, comprising the steps of:
designating a data program;
receiving said designated program at a set top box; and
transferring said received data program from said set top box to said computing device.

12. The method of claim 11, wherein said data program is designated during a video advertisement thereof.

13. The method of claim 11, wherein said data program is designated during an audio advertisement thereof.

14. The method of claim 11, wherein said data program is designated during a video demonstration thereof on a television, said television being coupled with said set top box.

15. The method of claim 14, wherein said video demonstration comprises a session on a home shopping channel.

16. The method of claim 11, further comprising the step of designating a format of said computing device, a version of said designated data program corresponding to said designated format being received at said set top box.

17. The method of claim 11, wherein a plurality of versions of said designated data program corresponding to a plurality of formats of said computing device are received at said set top box.

18. The method of claim 11, wherein said computing device is a personal computer.

19. The method of claim 11, wherein said computing device is a PDA.

20. The method of claim 11, wherein said computing is a telephone.

21. The method of claim 11, wherein said received data program is transferred to said computing device via a wireless transmission system.

22. The method of claim 21, wherein said wireless transmission system comprises BLUETOOTH™.

23. The method of claim 11, wherein said data program is transferred to said computing device via a data port.

24. The method of claim 11, wherein said received data program is transferred to said computing device only after payment for said received data program is confirmed.

25. The method of claim 24, wherein said payment is received at said set top box.

26. The method of claim 24, wherein said payment is received other than via said set top box, and said set top box is notified of receipt of said payment.

27. A method for downloading data to a computing device, comprising the steps of:
designating a data;
receiving a corresponding data corresponding to said designated data at a set top box; and
transferring said corresponding data from said set top box to said computing device.

28. The method of claim 27, wherein said designated data comprises a television program and said corresponding data comprises additional data related to said television program.

29. The method of claim 28, wherein said additional data comprises future scheduled times for other episodes of said television program.

30. The method of claim 27, wherein said designated data comprises a television commercial and said corresponding data comprises data about a product disclosed in said commercial.

31. The method of claim 30, wherein said corresponding data further comprises data about other products related to said product disclosed in said commercial.

32. A method for selecting a data program to be downloaded to a computing device, comprising the steps of:
designating a data program;
receiving said designated program at a set top box;
transmitting payment information from said set top box; and
transferring said received data program from said set top box to said computing device.

33. The method of claim 32, further comprising the steps of:
indicating the desire to remove said received data program from said computing device within a predetermined time period;
removing said received data program in accordance with said set top box; and
not charging said payment information.

34. The method of claim 32, wherein said payment information is maintained in said set top box.

35. An apparatus for selecting a data program to be downloaded to a computing device, comprising:
an input for receiving a designation of a data program; and
a receiver for receiving said designated program at a set top box.

36 The apparatus of claim 35, wherein said data program is designated during a video advertisement thereof.

37. The apparatus of claim 35, wherein said data program is designated during an audio advertisement thereof.

38. The apparatus of claim 35, wherein said data program is designated during a video demonstration thereof on a television, said television being coupled with said set top box.

39. The apparatus of claim 38, wherein said video demonstration comprises a session on a home shopping channel.

40. The apparatus of claim 35, further comprising an input for receiving an indication of a format of said computing device, a version of said designated data program corresponding to said designated format being received at said set top box.

41. The apparatus of claim 35, wherein a plurality of versions of said designated data program corresponding to a plurality of formats of said computing device are received at said set top box.

42. The apparatus of claim 35, wherein said computing device is a personal computer.

43. The apparatus of claim 35, wherein said computing device is a PDA.

44. The apparatus of claim 35, wherein said computing is a telephone.

45. An apparatus for downloading a data program to a computing device, comprising:
an input for receiving a designation a data program;
a receiver for receiving said designated program at a set top box; and
a transmission channel between said set top box to said computing device for transferring said received data program from said set top box to said computing device.

46. The apparatus of claim 45, wherein said data program is designated during a video advertisement thereof.

47. The apparatus of claim 45, wherein said data program is designated during an audio advertisement thereof.

48. The apparatus of claim 45, wherein said data program is designated during a video demonstration thereof on a television, said television being coupled with said set top box.

49. The apparatus of claim 48, wherein said video demonstration comprises a session on a home shopping channel.

50. The apparatus of claim 45, further comprising an input for receiving an indication of a format of said computing device, a version of said designated data program corresponding to said designated format being received at said set top box.

51. The apparatus of claim 45, wherein a plurality of versions of said designated data program corresponding to a plurality of formats of said computing device are received at said set top box.

52. The apparatus of claim 45, wherein said computing device is a personal computer.

53. The apparatus of claim 45, wherein said computing device is a PDA.

54. The apparatus of claim 45, wherein said computing is a telephone.

55. The apparatus of claim 45, wherein said received data program is transferred to said computing device via a wireless transmission system.

56. The apparatus of claim 55, wherein said wireless transmission system comprises BLUETOOTH™.

57. The apparatus of claim 45, wherein said data program is transferred to said computing device via a data port.

58. The apparatus of claim 45, wherein said received data program is transferred to said computing device only after payment for said received data program is confirmed.

59. The apparatus of claim 58, wherein said payment is received at said set top box.

60. The apparatus of claim 58, wherein said payment is received other than via said set top box, and said set top box is notified of receipt of said payment.

61. An apparatus for downloading data to a computing device:
designating means for designating a data;
receiving means for receiving a corresponding data corresponding to said designated data at a set top box; and
transfer means for transferring said corresponding data from said set top box to said computing device.

62. The apparatus of claim 61, wherein said designated data comprises a television program and said corresponding data comprises additional data related to said television program.

63. The apparatus of claim 62, wherein said additional data comprises future scheduled times for other episodes of said television program.

64. The apparatus of claim 61, wherein said designated data comprises a television commercial and said corresponding data comprises data about a product disclosed in said commercial.

65. The apparatus of claim 64, wherein said corresponding data further comprises data about other products related to said product disclosed in said commercial.

66. An apparatus for selecting a data program to be downloaded to a computing device, comprising:
designation means for designating a data program;
receiving means for receiving said designated program at a set top box;
transmission means for transmitting payment information from said set top box; and
transfer means for transferring said received data program from said set top box to said computing device.

67. The apparatus of claim 66, further comprising:
means for indicating the desire to remove said received data program from said computing device within a predetermined time period;
means for removing said received data program in accordance with said set top box; and
means for insuring that said payment information is not charged.

68. The apparatus of claim 66, wherein said payment information is maintained in said set top box.

69. A computer program for selecting a data program to be downloaded to a computing device, said computer program comprising:
an instruction for designating a data program; and
and instruction for receiving said designated program at a set top box.

70. A computer program for downloading a data program to a computing device, said computer program comprising:
an instruction for designating a data program;
an instruction for receiving said designated program at a set top box; and
an instruction for transferring said received data program from said set top box to said computing device.

71. A computer program for downloading data to a computing device, comprising:
an instruction for designating a data;
an instruction for receiving a corresponding data corresponding to said designated data at a set top box; and
an instruction for transferring said corresponding data from said set top box to said computing device.

72. A computer program for selecting a data program to be downloaded to a computing device, comprising:
an instruction for designating a data program;
an instruction for receiving said designated program at a set top box;
an instruction for transmitting payment information from said set top box; and
an instruction for transferring said received data program from said set top box to said computing device.

73. A storage medium storing instructions which, when executed on a programmed processor residing in a television set-top box, carry out the steps of:
designating a data program; and
receiving said designated program at a set top box.

74. A storage medium storing instructions which, when executed on a programmed processor residing in a television set-top box, carry out the steps of:
designating a data program;
receiving said designated program at a set top box; and
transferring said received data program from said set top box to said computing device.

75. A storage medium storing instructions which, when executed on a programmed processor residing in a television set-top box, carry out the steps of:
receiving a corresponding data corresponding to said designated data at a set top box; and
transferring said corresponding data from said set top box to said computing device.

76. A storage medium storing instructions which, when executed on a programmed processor residing in a television set-top box, carry out the steps of:
designating a data program;
receiving said designated program at a set top box;
transmitting payment information from said set top box; and
transferring said received data program from said set top box to said computing device.
